(19) United States
(12) Patent Application Publication
(10) Pub. No.: US 2003/0083450 A1
(43) Pub. Date: May 1, 2003

(54) Method and continous production of a solution of rubbers in vinyl-aromatic monomers

(76) Inventors: Gisbert Michels, Leverkusen (DE); Ludwig Deibele, Koln (DE); Markus Hadley, Leverkusen (DE); Torsten Hauschild, Bergisch Gladbach (DE); Ralph Ostarek, Valls (ES)

Correspondence Address: BAYER CORPORATION, 100 BAYER ROAD, PITTSBURGH, PA, 15205, US

(21) Appl. No.: 10/257,618

(22) PCT Filed: Apr. 4, 2001
(86) PCT No.: PCT/EP01/03812

(30) Foreign Application Priority Data
Apr. 18, 2000 (DE) 10019146.0

(51) Int. Cl. C08F 112/02

(52) U.S. Cl. 526/346

(57) ABSTRACT

Impact modified styrene polymers can be prepared by a continuous process for the production of a solution of rubber in vinyl aromatic monomers.

This invention relates to a continuous process for the production of a solution of rubbers in vinyl aromatic monomers and to the use of the rubbers dissolved in this manner in vinyl aromatic monomers for the production impact-modified styrene polymers (for example HIPS or ABS).

Numerous processes are known for the production of impact-modified styrene polymers and have been described and discussed in detail in, for example, WO 99/40136. As may be learnt from WO 99/40136, some hitherto known processes are associated with major disadvantages, as in many processes the rubber to be modified must first be isolated prior to further processing if it is to be used for impact modification, for example by polymerisation in the presence of a vinyl aromatic monomer. Such prior isolation of the rubber to be modified is costly and thus somewhat uneconomic.

In order to overcome these disadvantages, the attempt has also been made according to British patent 2 013 205 to use the rubber to be used for impact modification, for example of polystyrene, without prior isolation, by firstly polymerising butadiene in a relatively low-boiling solvent such as cyclohexane, then combining the solution with styrene and fractionating it, wherein the cyclohexane is removed by distillation together with the still unpolymerised butadiene monomer. The resultant solution of the rubber in styrene is then intended to be used conventionally in styrene polymerisation. As is explained in this regard in WO 99/40136, it has not been possible to make practical use of this per se elegant process probably because the solvent would have to be removed in an additional processing step in order to be able to perform the polymerisation at a sufficiently high monomer concentration.

WO 99/40136 accordingly proposed a continuous process for the production of thermoplastic moulding compositions, for example of impact-modified styrene polymers, in which anionic polymerisation of styrene is performed in one or more polymerisation reactors connected in series in the presence of a rubber produced in an immediately upstream process.

WO 98/31721 describes a similar process for the continuous production of impact-modified thermoplastic moulding compositions (HIPS), which is likewise performed in two or more reaction zones.

One disadvantageous feature of these processes is, inter alia, that they must be performed in two or more reaction stages, which entails considerable technical complexity.

The object of the present invention was to provide a continuous, technically simple to perform process for the production of solutions of rubber in vinyl aromatic monomers, which solutions may straightforwardly directly be used for modifying styrene polymers.

The present invention accordingly provides a process for the continuous production of a solution of rubbers in vinyl aromatic monomers, which process is characterised in that a 10 to 40 wt. % solution or suspension of a rubber in a hydrocarbon or hydrocarbon mixture as solvent or suspending agent having a boiling point at standard pressure which is at least 10° C. lower than that of the vinyl aromatic monomers is distilled, vinyl aromatic monomers are added to the distillation mixture before or during the distillation and distillation is performed continuously in such a manner that the bottom product assumes the form of a solution of the rubber used in the vinyl aromatic monomers in the range from 3 to 10 wt. %, wherein distillation is arranged such that the residence time of the rubber in the distillation column is in the range from 10 to 30 minutes, a reflux ratio of 1 to 5 is established, the bottom temperature is 20 to 80° C., the concentration of the hydrocarbon or hydrocarbon mixture used in the vinyl aromatic rubber solution in the distillation bottoms is ≦1 wt. % and the concentration of the vinyl aromatic monomers in the distillate is ≦5 wt. %.

Rubbers which may be used in the process according to the invention are those rubbers which are suitable for impact modification of thermoplastics based on vinyl aromatic compounds. Rubbers which may, for example, be considered are: polybutadienes, styrene/butadiene copolymers in random and/or block form, acrylonitrile/butadiene copolymers, chloroprene rubbers, ethylene/propylene rubbers, ethylene/propylene/diene rubbers as well as ethylene/α-olefin rubbers, preferably polybutadienes, styrene/butadiene copolymers in random and/or block form, ethylene/propylene rubbers, ethylene/propylene/diene rubbers and ethylene/α-olefin rubbers.

The rubbers to be used according to the invention may be produced using known processes, for example by anionic polymerisation of the underlying monomers, directly in inert hydrocarbons or hydrocarbon mixtures suitable for such polymerisation reactions and the corresponding solution or suspension of the rubber may be used immediately in the process according to the invention.

It is, of course, also possible to produce the rubbers to be used separately or to purchase them, then to dissolve or suspend them in suitable solvents or suspending agents and to use the resultant solution or suspension of the rubber in the process according to the invention.

Suitable hydrocarbons in which the rubbers to be used according to the invention may be dissolved or suspended are, for example, known aliphatic, cycloaliphatic or aromatic hydrocarbons having 4 to 12 carbon atoms, such as butane, pentane, hexane, heptane, octane or the corresponding isomers of the stated hydrocarbons, as well as cyclohexane, methylcyclohexane, benzene, alkylbenzenes, such as toluene, xylene, ethylbenzene, Decalin or mixtures thereof.

According to the invention, a 10 to 40 wt. %, preferably 15 to 30 wt. % solution or suspension of the stated rubbers in the stated hydrocarbons or mixtures thereof is used, wherein the solvents or suspending agents have a boiling point at standard pressure which is at least 10° C. below that of the vinyl aromatic monomers used.

The described solution or suspension of the rubbers is combined according to the invention with a vinyl aromatic monomer before or during distillation and distillation is performed continuously in such a manner that the bottom product assumes the form of a solution of the rubber used in the vinyl aromatic monomers preferably in the range from 5 to 9 wt. %, wherein distillation is arranged such that the residence time of the rubber in the distillation column is preferably in the range from 10 to 20 minutes, a reflux ratio of preferably 1 to 4 is established, the bottom temperature is preferably 40 to 80° C., the concentration of the hydrocarbon or hydrocarbon mixture used in the vinyl aromatic rubber solution in the distillation bottoms is preferably ≦0.1 wt. % and the concentration of the vinyl aromatic monomers in the distillate is preferably ≦1 wt. %.

Vinyl aromatic monomers which may preferably be considered are styrene, α-methylstyrene, α-methylstyrene dimer, p-methylstyrene, divinylbenzene, alkylstyrenes preferably having 2 to 6 carbon atoms in the alkyl residue as well as ring-substituted chlorostyrenes or mixtures thereof.

The rubber solution or suspension is distilled in a continuous distillation column consisting of a stripping section and an enrichment section, wherein the hydrocarbon or hydrocarbon mixture is separated in the stripping section of the column and the rubber dissolved in the vinyl aromatic monomers is obtained in the column bottom. The separated hydrocarbons or hydrocarbon mixtures are concentrated in the enrichment section of the column and discharged as a distillate and may be reused for dissolving or suspending the rubbers to be used.

Any usual column internals such as trays, packing materials or ordered packings may be used in the enrichment section of the column. Packing materials or ordered packings should preferably be used in the stripping section, through which a viscous liquid flows due to the rubber content. As a result, the stripping section has no comers or edges where, in the event of extended residence times, polymer fractions may be damaged by exposure to elevated temperatures or precipitate as solids, so blocking the column.

It is essential to the process according to the invention that, as mentioned, distillation is arranged such that a certain residence time of the rubber in the distillation column is maintained, as are likewise a certain reflux ratio, a certain bottom temperature and a certain concentration of the hydrocarbon or hydrocarbon mixture used in the vinyl aromatic rubber solution in the distillation bottoms and a certain concentration of the vinyl aromatic monomers in the distillate.

In the process according to the invention, a solution of rubbers in vinyl aromatic monomers is accordingly obtained in which the rubber used is present in the distillation bottoms at a concentration of conventionally 3 to 10 wt. % in the vinyl aromatic monomers.

Should a higher concentration of the rubber in vinyl aromatic monomers be required for the production of impact-modified thermoplastics, a proportion of the vinyl aromatic monomers may be evaporated in a further evaporation stage depending upon the desired concentration and viscosity of the rubber solution, the evaporation stage taking the form, in order of increasing viscosity, of falling film evaporation, flash evaporation or an evaporating extruder.

Polymerisation inhibitors may be added to the vinyl aromatic monomers in order to avoid polymerisation of the vinyl aromatic monomers used during the distillative solvent exchange. It may furthermore be advisable to add stabilisers likewise to avoid crosslinking of the rubber during the distillative solvent exchange. The polymerisation inhibitors and stabilisers may be added before or during solvent exchange. Examples of inhibitors and stabilisers which may be considered are tert.-butylpyrocatechol, hydroquinone monomethyl ether, triethylene glycol bis-3(3-tert.-butyl-4-hydroxy-5-methylphenyl) propionate, octadecyl-3-(3,5-di-tert.-butyl-4-hydroxyphenyl) propionate, tris(nonylphenyl) phosphite, tris(2,4-di-tert.-butylphenyl) phosphite, 2-methyl-4,6-bis[(octylthio)methyl]phenol, dilauryl thiodipropionate. The most favourable quantity of inhibitors and/or stabilisers to be added may readily be determined by appropriate preliminary testing.

The solutions produced according to the invention of rubbers of the stated kind in the mentioned vinyl aromatic monomers may be used for the production of impact-modified thermoplastic moulding compositions, for example for the production of impact-modified styrene polymers such as impact-modified polystyrene (HIPS), impact-modified polymers of the ABS and AES type.

The impact-modified thermoplastic moulding compositions may here be produced in the conventional manner by free-radically polymerising the vinyl aromatic monomers in known manner.

It is, of course, possible to add still further suitable monomers to the vinyl aromatic monomers, such as ethylenically unsaturated nitrile monomers, preferably acrylonitrile and methacrylonitrile, in particular acrylonitrile, or acrylic acid monomers or maleic acid monomers, in order to obtain the desired impact-modified thermoplastic moulding compositions. Examples of acrylic acid monomers or maleic acid derivatives which may be considered are methyl (meth)acrylate, ethyl (meth)acrylate, tert.-butyl (meth)acrylate, esters of fumaric and itaconic acid, maleic anhydride, maleic acid esters, N-substituted maleimides, such as N-cyclohexyl- or N-phenylmaleimide, N-alkylphenylmaleimide together with acrylic acid, methacrylic acid, fumaric acid and the amides thereof. Free-radical polymerisation of the vinyl aromatic compounds in the presence of rubbers for the production of impact-modified thermoplastic moulding compositions is known and described, for example, in Houben-Weyl, Methoden der organischen Chemie, volume E20, part 1, pp. 182 to 217, Georg Thieme Verlag, Stuttgart and U.S. Pat. No. 4,587,294, U.S. Pat. No. 5,286,792, EP-A 376 232, U.S. Pat. No. 5,278,253, EP-A 277 687, EP-A 657 479, U.S. Pat. No. 3,538,190, DE-A 2 516 834, U.S. Pat. No. 3,449,471.

The rubber-modified thermoplastic moulding compositions according to the invention produced from the corresponding solutions of the rubbers in the vinyl aromatic monomers have rubber particle sizes with a diameter (weight average, d_{W}) of 0.01 to 15 μm, preferably of 0.05 to 15 μm.

The moulding compositions modified in this manner may be melt-processed to yield mouldings of all kinds by extrusion, injection moulding, calendering, blow moulding, pressing and sintering.

### EXAMPLE

The rubber solution is produced by anionic polymerisation in accordance with the known prior art. The polybutadiene comprises a star-branched polymer having a 1,2-vinyl content of 10%, a cis-1,4 content of 37%, a trans-1,4 content of 53%, a Mooney viscosity (ML 1+4 @ 100° C., MU) of 59 and a solution viscosity of 44 mPas (5 wt. % in styrene). After the anionic polymerisation of 1,3-butadiene in hexane, a 23 wt. % rubber solution in hexane is obtained, which is to be converted into a rubber solution in styrene. To this end, 100 g of the rubber solution in hexane are mixed with 178 g of styrene and 0.14 g of tris(nonylphenyl) phosphite and 0.046 g of octadecyl-3-(3,5-di-tert.-butyl-4-hydroxyphenyl) propionate, such that the mixture contains 27.7% hexane, 64.0% styrene and 8.3% rubber. This mixture was introduced into a laboratory distillation column (diameter 50 mm, packing height 2 m in the stripping section and 1 m in the enrichment section, filled with Rombopack 9M ordered packing from Kühni). Heating was performed with a falling film evaporator.

The column was operated continuously at a top pressure of 100 mbar and a reflux ratio of 2. The feed rate was 356 g/h of the solution comprising 27.7% hexane, 64.0% styrene and 8.3% rubber. Heating was performed by blowing 135 g/h of styrene vapour originating from the falling film evaporator into the bottom of the column. Under these conditions, the quantity of distillate was 99 g/h containing <0.5 wt. % styrene and the quantity discharged from the bottom 392 g/h containing <300 ppm hexane. The bottom product, a 7.4 wt. % rubber solution in styrene, was obtained at a temperature of 74° C. and exhibited a viscosity of approx. 250 mPas. This rubber solution was pumped to the falling film evaporator, where, out of a quantity of 392 g/h, 135 g/h of styrene were evaporated off and passed to the column. The remaining 257 g/h of rubber solution contained 11.3% rubber. At a temperature in the falling film evaporator of 75° C., the rubber solution exhibited a viscosity of 900 mPas. An additional evaporation stage is required to increase the rubber concentration any further.

Production of ABS Moulding Compositions

A solution consisting of 1137 g of the previously obtained 11.3 wt. % rubber solution in styrene, 344.6 g of acrylonitrile, 335.8 g of methyl ethyl ketone, 0.26 g of octadecyl-3-(3,5-di-tert.-butyl-4-hydroxyphenyl) propionate and 2.03 g of alpha-methylstyrene dimer is mixed at 40° C. with an anchor stirrer (150 rpm) in a 5 litre, flat-ground joint vessel equipped with an anchor stirrer and reflux condenser. Once this solution has been heated to 82-85° C., the initiator solution consisting of 118.5 g of methyl ethyl ketone and 4.24 g of tert.-butyl perpivalate (57%) is apportioned within 4 hours. Throughout the entire reaction, the temperature is controlled in such a manner that slight reflux prevails (82-85° C.). After two hours from the beginning of addition of the initiator solution, a solution consisting of 39.5 g of methyl ethyl ketone and 7.43 g of alpha-methylstyrene dimer is added in 1-2 minutes, then the stirrer is set to 100 rpm. Once addition of the initiator solution is complete, stirring is continued for a further 2 hours at 85° C., then the mixture is cooled to room temperature. A solution of 1.88 g of octadecyl-3-(3,5-di-tert.-butyl-4-hydroxyphenyl) propionate and 2.82 g of dilauryl thiodipropionate in 197.5 g of methyl ethyl ketone is then added for stabilisation purposes. The solution is then evaporated in a twin-screw laboratory evaporating extruder and pelletised.

Monomer conversion was 52.1%, the rubber content of the ABS moulding compositions was 15.3%. The gel content (with acetone as solvent) was 30.3%. Intrinsic viscosity, measured in dimethylformamide with 1 g/l LiBr, was 0.546 dl/g. The melt volume index (MVI 220° C./10 kg) to DIN 53 735 was 6.4 g/10 min.

Particle size and distribution were measured by centrifugation as described in U.S. Pat. No. 5,166,261; at variance with this method, a dispersion of the rubber particles in propylene carbonate was injected into a mixture of propylene carbonate/acetone (75:25); the weight average (d_{W}), area average (d_{A}) and number average (d_{N}) are stated ([μm]).

| Before evaporation | | | | After evaporation | | | |
|---|---|---|---|---|---|---|---|
| | | | Fraction | | | | Fraction |
| d_{W} | d_{A} | d_{N} | >1 μm | d_{W} | d_{A} | d_{N} | >1 μm |
| 0.474 | 0.237 | 0.115 | 0.064 | 0.559 | 0.202 | 0.106 | 0.075 |

1. Process for the continuous production of a solution of rubbers in vinyl aromatic monomers, characterised in that a 10 to 40 wt. % solution or suspension of a rubber in a hydrocarbon or hydrocarbon mixture as solvent or suspending agent having a boiling point at standard pressure which is at least 10° C. lower than that of the vinyl aromatic monomers is distilled, vinyl aromatic monomers are added to the distillation mixture before or during the distillation and distillation is performed continuously in such a manner that the bottom product assumes the form of a solution of the rubber used in the vinyl aromatic monomers in the range from 3 to 10 wt. %, wherein distillation is arranged such that the residence time of the rubber in the distillation column is in the range from 10 to 30 minutes, a reflux ratio of 1 to 5 is established, the bottom temperature is 20 to 80° C., the concentration of the hydrocarbon or hydrocarbon mixture used in the vinyl aromatic rubber solution in the distillation bottoms is ≦1 wt. % and the concentration of the vinyl aromatic monomers in the distillate is ≦5 wt. %.

2. Process according to claim 1, characterised in that the bottom product assumes the form of a solution of the rubber used in the vinyl aromatic monomers in the range from 5 to 9 wt. %, distillation is arranged such that the residence time of the rubber in the distillation column is in the range from 10 to 20 minutes, a reflux ratio of 1 to 4 is established, the bottom temperature is 40 to 80° C., the concentration of the hydrocarbon or hydrocarbon mixture used in the vinyl aromatic rubber solution in the distillation bottoms is ≦0.1 wt. % and the concentration of the vinyl aromatic monomers in the distillate is ≦1 wt. %.

3. Process according to claim 1, characterised in that aliphatic, cycloaliphatic and/or aromatic hydrocarbons having 4 to 12 carbon atoms are used as the solvent or suspending agent.

4. Process according to claim 1, characterised in that polybutadienes, styrene/butadiene copolymers in random and/or block form, acrylonitrile/-butadiene copolymers, chloroprene rubbers, ethylene/propylene rubbers, ethylene/propylene/diene rubbers and/or ethylene/α-olefin rubbers are used as the rubbers.

5. Process according to claim 1, characterised in that styrene, α-methylstyrene, α-methylstyrene dimer, p-methylstyrene, divinylbenzene, alkylstyrenes having 2 to 6 carbon atoms in the alkyl residue and/or chlorostyrenes are used as the vinyl aromatic monomers.

6. Process according to claim 1, characterised in that a 15 to 30 wt. % solution or suspension of a rubber in a hydrocarbon or hydrocarbon mixture is used as solvent or suspending agent.

7. Use of rubber solutions according to claims 1 to 6 for the production of impact-modified styrene polymers.
